(19) United States
(12) Patent Application Publication
(10) Pub. No.: US 2011/0107223 A1
(43) Pub. Date: May 5, 2011

(54) User Interface For Presenting Presentations

(76) Inventors: Eric Tilton, Austin, TX (US); Michael Peirce, Lewis Center, OH (US); Jay Capela, San Francisco, CA (US); Roger Rosner, Pittsburgh, PA (US); Jay Holtorf, San Jose, CA (US)

(21) Appl. No.: 12/987,986

(22) Filed: Jan. 10, 2011

Related U.S. Application Data
(63) Continuation of application No. 10/337,767, filed on Jan. 6, 2003, now abandoned.

(51) Int. Cl. G06F 3/00; G06F 3/048

(52) U.S. Cl. 715/730; 715/848

(57) ABSTRACT

A user interface and methods for presenting presentation pages are described herein. In one aspect of the invention, an exemplary method of the invention displays a first presentation page in a display area of a data processing system. Next, a second presentation page angles into the display area as the first presentation page angles out and turns off from the display area, as though they are sides of a revolving 3-D object. Other methods and apparatuses are also described.

This application is a continuation of co-pending U.S. patent application Ser. No. 10/337,767, filed Jan. 6, 2003, entitled “User Interface for Presenting Presentations” and assigned to a common assignee of the present application

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright Apple Computer, Inc., 2002.

### FIELD OF THE INVENTION

The present invention relates to methods, such as user interfaces, for presenting presentations and more particularly, relates to presenting slide presentations.

### BACKGROUND OF THE INVENTION

Slide presentation programs are computer programs that enable a user to create, edit, manage, and perform “presentations” on a computer. One example of a popular slide presentation program is Microsoft PowerPoint, available from Microsoft Corporation, of Redmond, Wash. A slide presentation includes a set of electronic “slides,” each slide corresponding to one screen or page of output. An electronic slide may also be converted to a 35-mm slide or overhead transparency and displayed in a standard slide projector or overhead projector. Each slide contains one or more objects, such as text, graphical images, or graphical animation. A slide may also include a sound object that is played when the slide is displayed during a “slide show” performance.

A slide presentation program “performs” a “slide show” by sequentially displaying a series of slides contained within the slide presentation. The slides are displayed on a display screen, which may be part of a computer monitor or a separate surface onto which an image is projected. During a performance of a slide show, a speaker controls the performance by invoking commands to advance the slide show. A command can be entered using a keyboard, a mouse, or other suitable input device. Alternatively, an author of a slide presentation can include slide “timings” with each slide. A slide timing corresponding to a slide indicates the number of seconds that the slide is displayed before the slide presentation program automatically advances to the next slide. During a performance of a slide show, the slide presentation program automatically advances to the next slide when the existing slide's timing ends.

A slide can include one or more display objects that are incrementally displayed during a slide show. For example, a slide may initially appear with one bullet item. Sequential advancement of the slide show causes additional bullet items to be displayed. Display objects, such as bullet items, that are incrementally displayed are referred to as “builds.” However, conventional slide presentation programs typically present slides through a “next” button such that a new slide replaces an old slide without a transition between the new and old slides. It is desirable to be able to present a presentation through an object having a transition to phase in the new slide and phase out the old slide.

### SUMMARY OF THE DESCRIPTION

The present invention relates to various aspects for presenting presentations via a three-dimensional (3-D) manner. In one aspect of the invention, an exemplary method of the invention displays a first presentation page in a display area of a data processing system. Next, a second presentation page angles into the display area as the first presentation page angles out and turns off from the display area through a 3-D object, as though they are sides of a revolving 3-D object. In one particular embodiment, the 3-D object is a 3-D cube, a flipping panel, or tiles shimmering or flipping across the display area. In a further embodiment, the revolving 3-D object may occupy an area larger than the original display area during the transition.

The present invention also discloses machine readable media which may be executed by a processor to perform the above methods. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIGS. 1A and 1B show a GUI (Graphical User Interface) illustrating an exemplary presentation program interface, in accordance with one embodiment of the invention.

FIGS. 2A to 2C show a GUI (Graphical User Interface) illustrating an exemplary interface to set up a transition of a 3-D object to present a presentation page, in accordance with one embodiment of the invention.

FIGS. 3A and 3B are a series of block diagrams illustrating a transition of a 3-D cube to present a presentation page, in accordance with one embodiment of the invention.

FIGS. 4A and 4B are a series of block diagrams illustrating a transition of a 3-D panel to present a presentation page, in accordance with one embodiment of the invention.

FIGS. 5A and 5B are a series of block diagrams illustrating a transition of 3-D tiles to present a presentation page, in accordance with one embodiment of the invention.

FIG. 5C is a series of block diagrams illustrating a transition of 3-D tiles to present a presentation page, in accordance with another embodiment of the invention.

FIG. 6 shows a flow diagram illustrating an exemplary process to present a presentation page in a 3-D manner, in accordance with one embodiment of the invention.

FIG. 7 is a block diagram of a digital processing system which may be used to present a presentation page via a transition of a three-dimensional (3-D) object, in accordance with one embodiment of the invention.

FIGS. 8A to 8E are a series of block diagrams illustrating transitions of 2-D objects to present a presentation page, in accordance with alternative embodiments of the invention.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are used by those skilled in the data processing arts to most effectively convey the substance of their work to others skilled in the art. An algorithm is generally conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these terms and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar data processing device, that manipulates and transforms data represented as physical (e.g. electronic) quantities within the computer system's registers and memories into other data similarly represented as physical quantities within the computer system memories or registers or other such information storage, transmission or display devices.

The present invention also relates to apparatuses for performing the operations described herein. An apparatus may be specially constructed for required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as Dynamic RAM (DRAM), EPROMs, EEPROMs, magnetic or optical cards, or any type of media suitable for storing electronic instructions, and each of the above storage components is coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the methods. The structure for a variety of these systems will appear in the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other forms of propagated signals (e.g., carrier waves, infrared signals, digital signals, etc.).

Embodiments of the invention allow a user to create a presentation, such as a slide presentation, in a three-dimensional (3-D) manner on a data processing system. In one embodiment, a presentation page is attached to a surface of a 3-D object and the presentation page is presented by rotating or flipping the 3-D object to phase the presentation page into a display area. Meanwhile, an existing presentation page may be phased out of the display area on another surface of the 3-D object through the rotation.

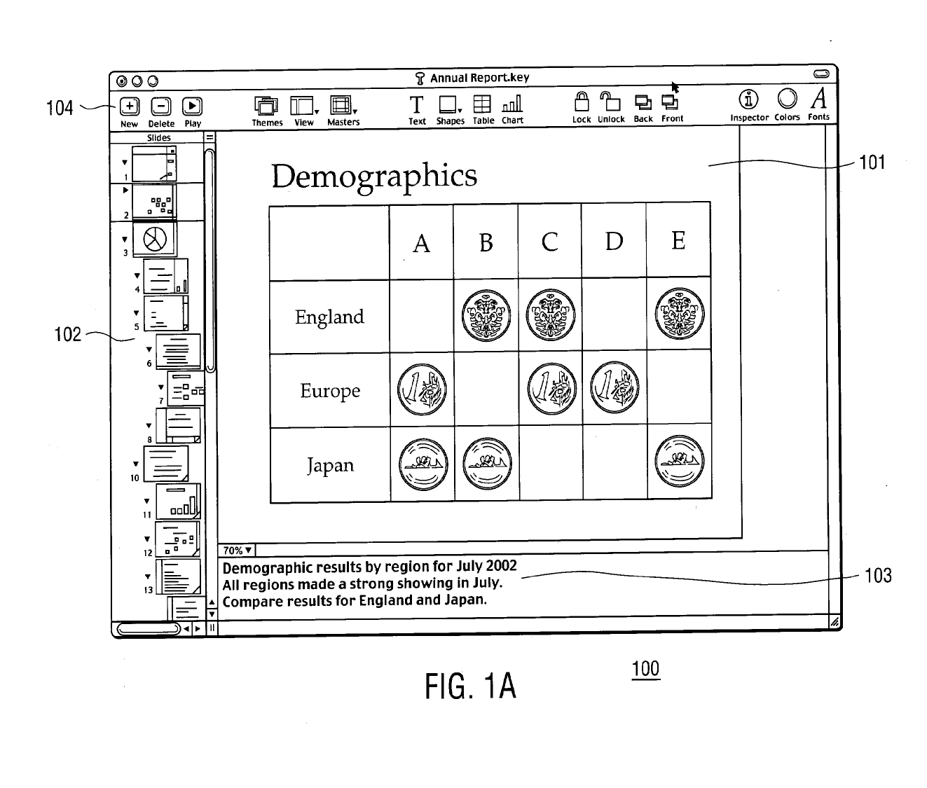

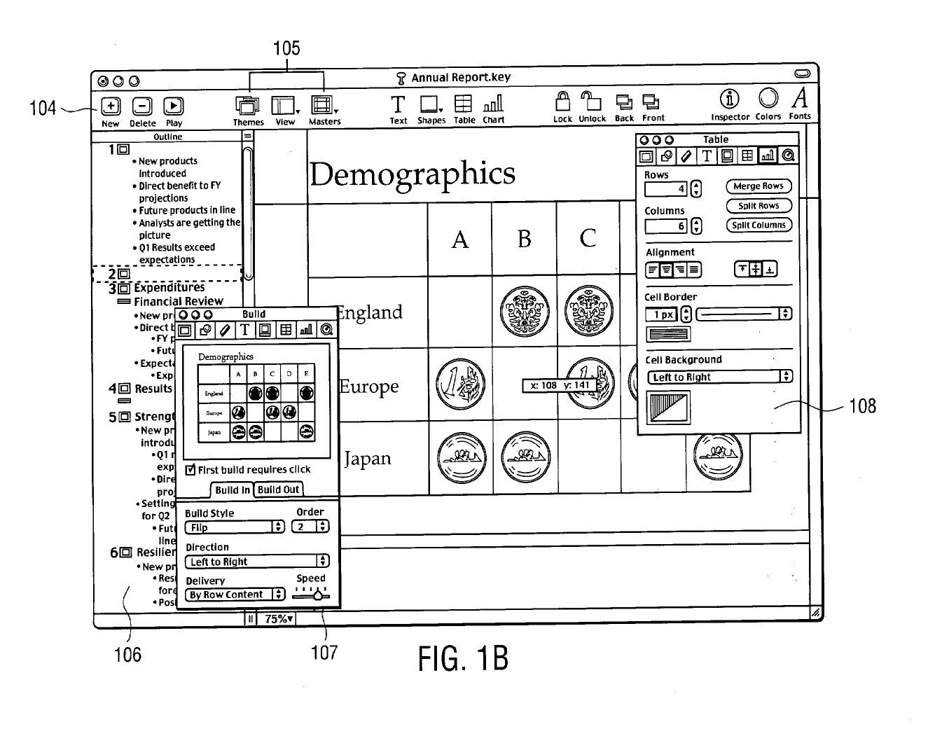

FIGS. 1A and 1B are exemplary graphical user interfaces (GUIs) of which a 3-D presentation may be generated according to one embodiment of the invention. In this embodiment, the GUI 100 is a slide presentation GUI. It would be appreciated that such GUI may be utilized in other presentation programs. Referring to FIG. 1A, the exemplary GUI 100 includes a slide canvas 101, a slide organizer 102, and a note field 103. Slide canvas 101 is where a user designs each slide. In one embodiment, a user may easily drag graphic files, movie files, and audio files to the canvas to add them to the slideshow. A user may create a slideshow using a theme, which lets the user work with a family of master slides to create a handsome and cohesive look throughout the presentation. Different master slides within each theme make it easy to add titles and bulleted text in effective visual layouts. As a user works on designing the slides, the user may zoom in or out to get a better view at what he/she is doing.

Slide organizer 102 allows a user to organize slides in the presentation. The slide organizer 102 allows a user to “indent” the slides such that more than one slide may be grouped together. In one embodiment, some slides may be hidden when the user does not want them to appear in the slideshow. In one embodiment, the slide organizer 102 has two views: navigator view, which is useful for graphic intensive presentations, as shown in FIG. 1A, and outline view, such as slide organizer 106 shown in FIG. 1B, which is useful for text heavy presentations. In navigator view, the slide organizer displays a thumbnail image of each slide in the presentation, which makes it easy to see the flow of graphic-rich presentations. The outline view shows the text content of each slide in the presentation. The outline view is useful to see the flow of text-rich presentations. All of the titles and bullet points appear legibly in the slide organizer. The outline view may provide an easy way to order and re-order the bullet points as the user organizes the presentation. Additional bullet points may be directly added to existing bullet points in the slide organizer.

Notes field 103 is an area in which a user can type or view notes for each slide. These notes are not visible in the slide show presentation but can be viewed on an alternative display or printed as a talking aid to use during the slideshow presentation. In addition, the exemplary GUI 100 includes a tool bar 104 to provide one-click access to actions that a user would use when creating presentations. One or more buttons may be added to or removed from the tool bar 104. In one embodiment, among other things, the tool bar 104 includes buttons 105 to select a theme to create a master slide. Furthermore, the exemplary GUI 100 further includes one or more inspectors, such as a build inspector 107 and a table inspector 108, to control the appearance of each slide.

According to one embodiment, when a slide presentation is created, a master document is created. The entire slideshow, including all of the graphics and any chart data, are contained within the master document, which can be easily moved from one computer to another. If a user adds movies or sound to the document, the user may choose to save them as a part of the master document. Once the presentation is finished, the presentation can be viewed in several ways. In one embodiment, a user can watch the presentation on a computer. Alternatively, the presentation can be viewed by projecting it from a computer to a screen, printing it, or exporting it to other applications, such as QuickTime available from Apple Computer, Inc., PowerPoint available from Microsoft Corporation, or a PDF format defined by Adobe System Incorporated. As a result, the presentation can be viewed on other computer platforms. Furthermore, the presentation may be viewed or played remotely over a network via a video conferencing program. The network may be an Internet or, alternatively, an Intranet within an organization.

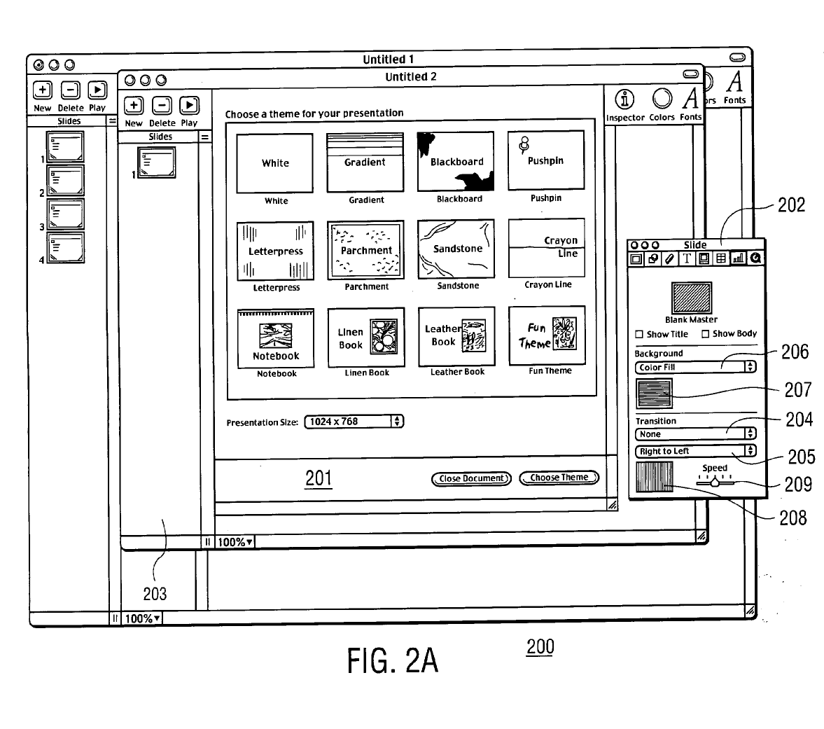

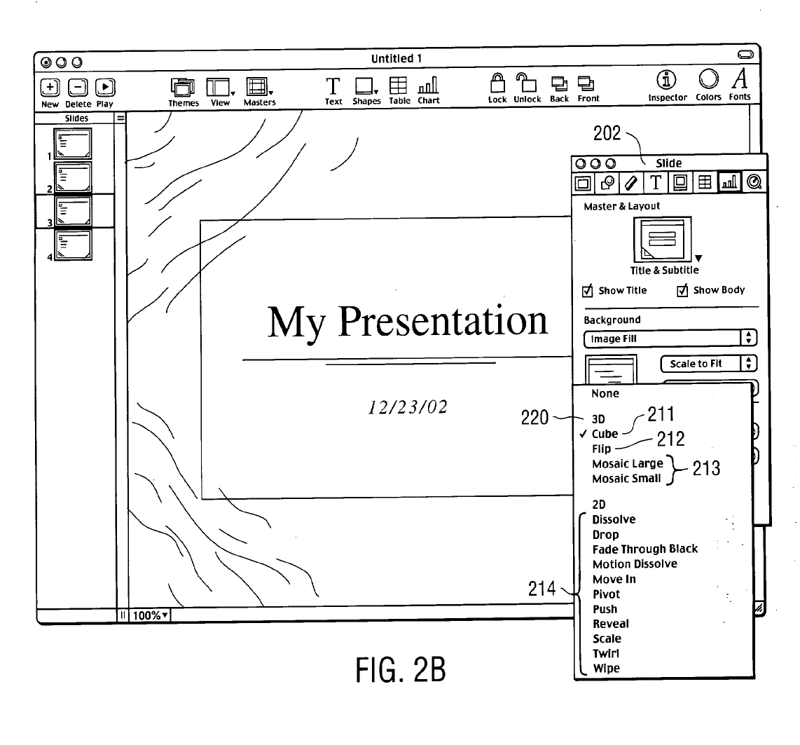

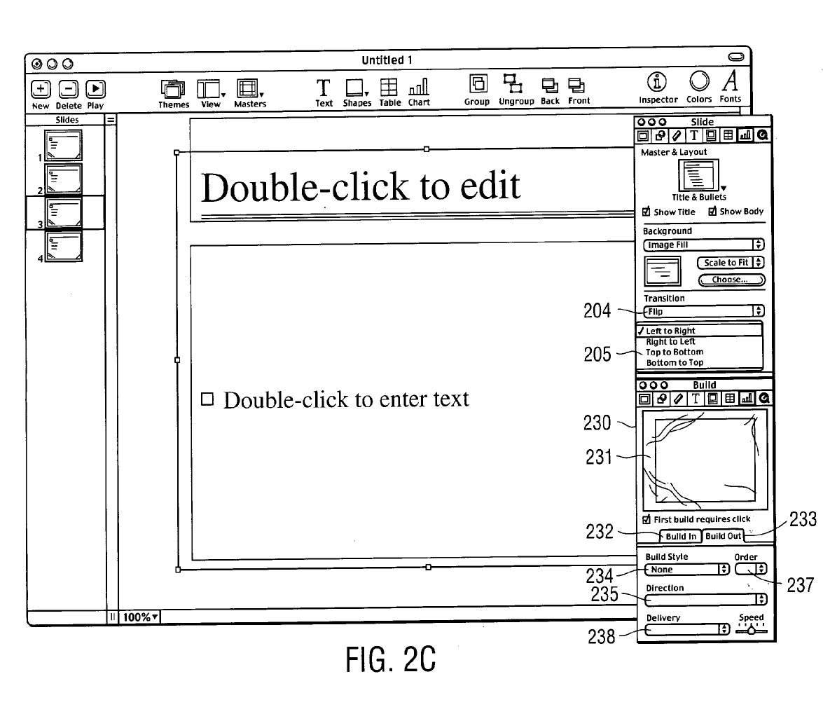

When a user starts to create a presentation, the user may select a theme for the presentation. By using a theme, a presentation may be created with a cohesive look and feel with little or no design work for the user. FIGS. 2A to 2C show a GUI of which a 3-D slide presentation may be created in accordance with one embodiment of the invention. Referring to FIG. 2A, the exemplary GUI 200 includes, among other components, a slide organizer 203, a window to present a plurality of themes 201 that a user may choose from, and a slide inspector 202 to control the appearance of a master slide. Slide organizer 203 may be used to organize the slide presentations. Slide organizer 203 may be viewed in a navigator view or an outline view. Each theme of the plurality of themes 201 may include a set of slide layouts or templates (also referred to as master slides) with styled text, bullets, and other formatting features already built-in. The user can choose a look from among a broad variety of textures and moods, it is like having a great design house at a user's fingertips.

When a theme is selected, a slide 210 appears in the slide organizer 203. A user can begin working in slide 210 as a first slide, adding text, graphics, and sound. More slides may be added to the project. Each theme may include a family of master slides. Each master slide may have a different layout for title and body text, as well as blank areas for graphics. A slide inspector 202 associated with a master slide (e.g., slide 210) may be displayed and used to control the appearance of the master slide. In one embodiment, each slide shown in the slide organizer 203 is associated with a corresponding slide inspector, such as slide inspector 202.

In one embodiment, among other components, slide inspector 202 includes a field, such as a pull-down menu 206, to set a background of the slide. For example, a user may choose to have the background filled with a color or colors. Alternatively, a user may insert an image specified by the user as the background of any individual slide. A preview of the background of the slide may be shown as a thumbnail in a field 207.

In one embodiment, the slide inspector 202 includes a transition field 204 to allow a user to specify a transition of a slide when it is presented. In another embodiment, the transitions of a slide include a 3-D cube that allows a new slide to phase into a display area on one surface of the 3-D cube while an existing slide is phasing out from the display area on another surface of the 3-D cube. As a result, an old slide angles and turns off the screen (e.g., the display area) as a new slide angles on the screen, as though they are sides of a revolving cube. In an alternative embodiment, the slides may be construed as a 3-D panel, such that a new slide is phased into the display area by flipping the panel to show the other side of the panel which contains the new slide. As a result, an old slide angles and turns off the screen as a new slide angles on screen, as though they are two sides of a revolving coin. In a further embodiment, new slides are built on square tiles that shimmer across the display area. In yet another embodiment, a new slide may move in from one direction to cover the contents of the previous slide. In a yet further embodiment, a new slide draws in a sweep from one direction, as the previous slide is erased from the same direction. In yet a further embodiment, a new slide grows from the center of the previous slide outward to fill the display area. Alternatively, a previous slide may shrink away to the center of the display area and reveal the next slide. Other transitions apparent to those with ordinary skill in the art may be utilized.

In addition, the slide inspector 202 includes a direction field 205 to specify a direction of a transition selected from the transition field 204. Furthermore, the slide inspector 202 includes a speed field 209 to control the speed of the transition specified in the transition field 204. A user may drag the slider to adjust the speed of the transition. A preview of the slide may be presented as a thumbnail in field 208.

Referring now to FIG. 2B, when a user selects a transition by clicking or selecting a pull-down menu 204 to select a transition type of the slide, menu 220 is popped up to display several styles including 3-D styles of cube 211, flip 212, and mosaic 213. 2-D styles 214 are also available from which to choose. For example, as shown in FIG. 2C, after a user selects a transition of “flip” from the pull-down menu 204, the user may want to select a direction for the transition from the pull-down menu 205. Typical directions include left-to-right, right-to-left, top-to-bottom, and bottom-to-top. The direction of each style of transitions may vary.

According to one embodiment, to add visual interest to the slide presentations, a user can create objects builds on each slide. Object builds allow a user to animate the elements on a single slide one at a time or in groups in any order. For example, a user might have an image move in from a left side of the screen and then, line by line, display the bulleted text that goes alongside it. Object builds can be configured through a build inspector 230. Object builds include a build-in animation 232 to move slide elements on the screen and a build-out animation 233 to move elements off screen. A preview of the slide presentation can be viewed as a thumbnail in a preview area 231. Each of the build-in and build-out animation allows a user to select an animation from the build style pop-up menu 234. A user may select graphic objects, bulleted text, labels, or other text objects, and sound objects from the build style menu 234. A user may also choose the direction from which the object is moved onto the slide from the direction pop-up menu 235. The speed of the animation may be adjusted through the speed slider. Once a user has selected a build style for each of the items on the slide that the user wants to animate, those items may be assigned to an order using the order pop-up menu 237. Some of those items may be delivered in a manner (e.g., by column or by row) configured by delivery pop-up menu 238. When a slide is played, the objects will move onto the screen in the order set up by the build inspector. Similarly, build-out animation can be configured by a corresponding tab 233.

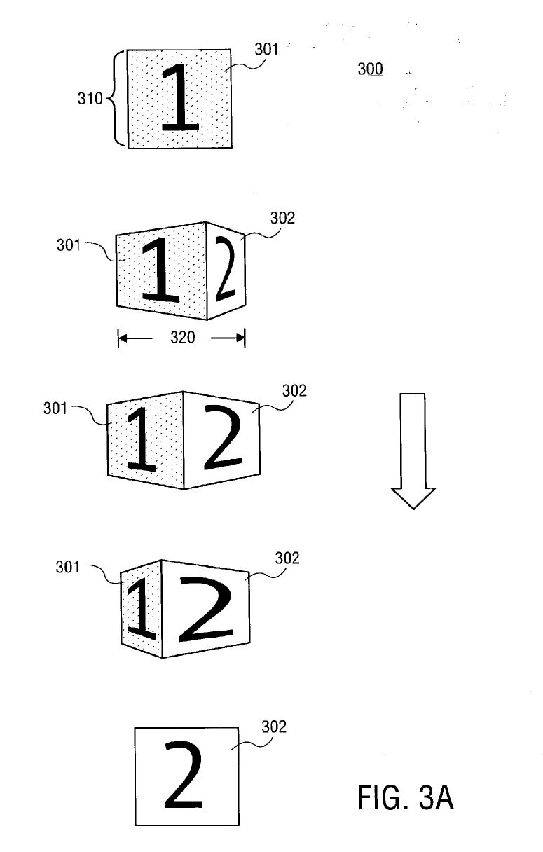

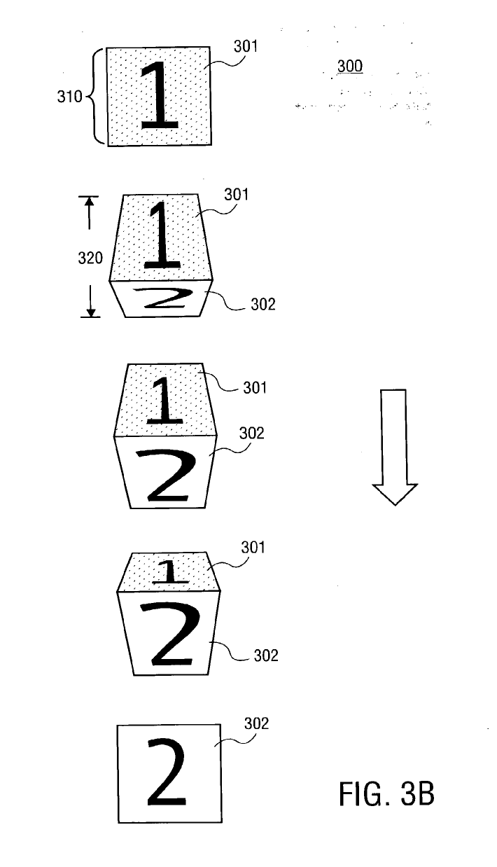

As discussed above, according to one embodiment, the transitions of a slide include a 3-D cube that allows a new slide to phase into a display area on one surface of the 3-D cube while an existing slide is phasing out from the display area on another surface of the 3-D cube. As a result, an old slide angles and turns off the screen (e.g., the display area) as a new slide angles on the screen, as though they are sides of a revolving cube, as shown in FIGS. 3A and 3B. Referring to FIGS. 3A and 3B, a new slide phases into the display area on side 302 of the 3-D cube 300 while the existing slide is phasing out from the display area on side 301 of the 3-D cube 300, as though they are two sides (e.g., sides 301 and 302) of the 3-D cube 300. In one embodiment, during the phasing in and out, the revolving 3-D cube occupies an area measured by 320 larger than the display area measured by 310. The direction of the revolving cube may be controlled through a direction pop-up menu of the corresponding slide inspector, such as the direction pop-up menu 205. For example, the revolving cube shown in FIG. 3A has a direction of right-to-left, while the one shown in FIG. 3B has a direction of bottom-to-top. In a typical slide presentation, the number of slides often will exceed the number of sides of a cube or other 3-D objects. For example, the number of slides may be 10 or 12, which exceeds the 6 sides of a cube.

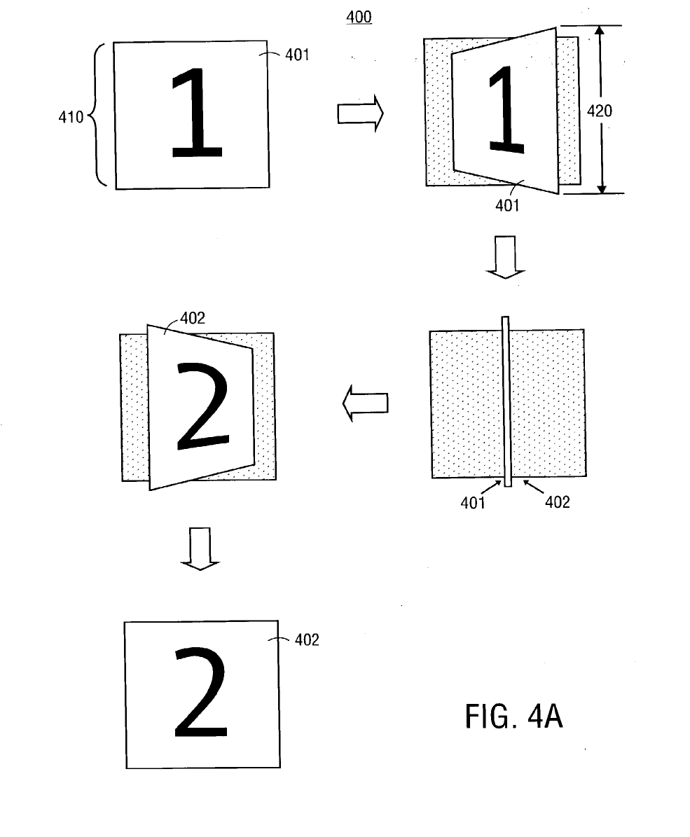

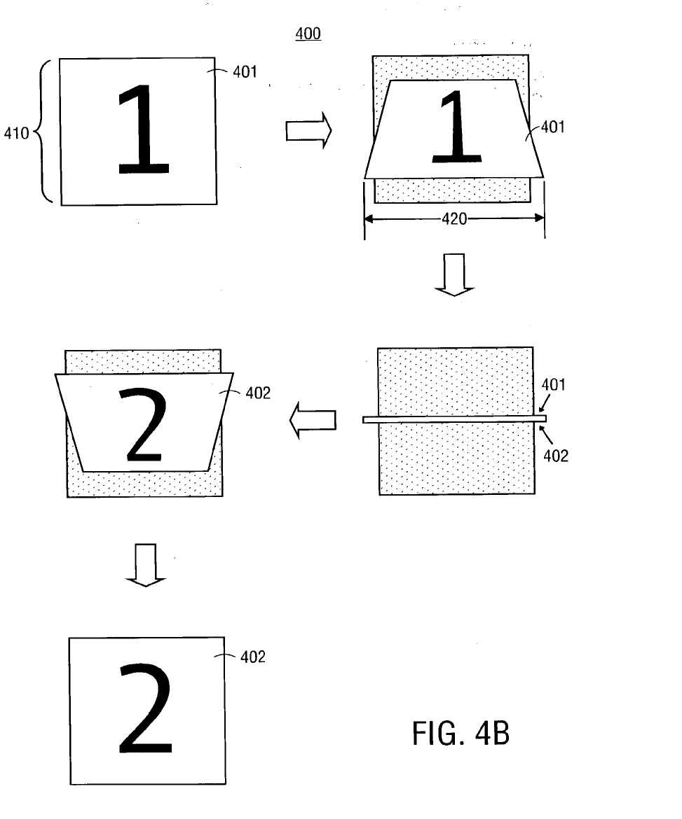

In an alternative embodiment, the slides may be construed as a 3-D panel, such that a new slide is phased into the display area by flipping the panel to show the other side of the panel which contains the new slide. As a result, an old slide angles and turns off screen as a new slide angles on screen, as though they are two sides of a revolving coin, as shown in FIGS. 4A and 4B. Referring to FIGS. 4A and 4B, a new slide phases into the display area on side 402 of the 3-D panel 400 while the existing slide is phasing out from the display area on side 401 of the 3-D panel 400, as though they have two sides (e.g., sides 401 and 402) of the 3-D panel 400. In one embodiment, during the phasing in and out, the revolving 3-D panel 400 occupies an area measured by 420 larger than the display area measured by 410. The direction of the flipping panel may be controlled through a direction pop-up menu of the corresponding slide inspector, such as the direction pop-up menu 205. For example, the flipping panel shown in FIG. 4A has a direction of right-to-left, while the one shown in FIG. 4B has a direction of bottom-to-top.

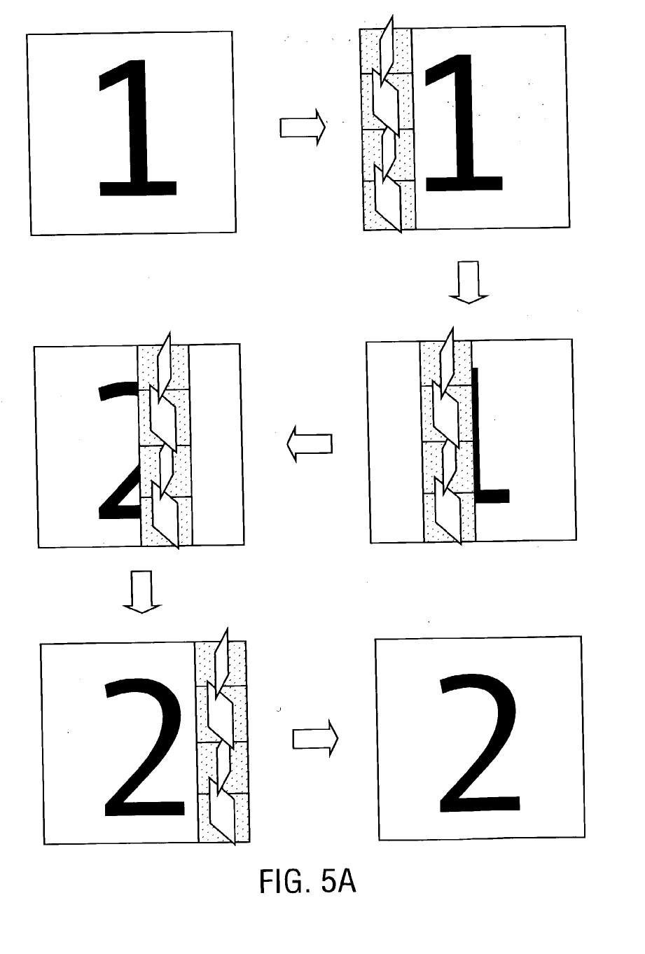

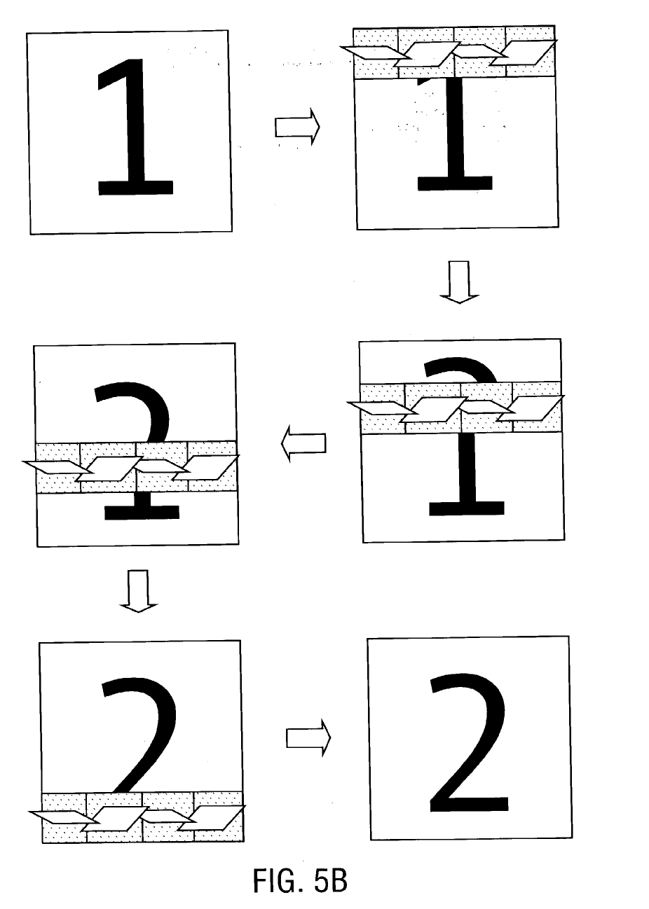

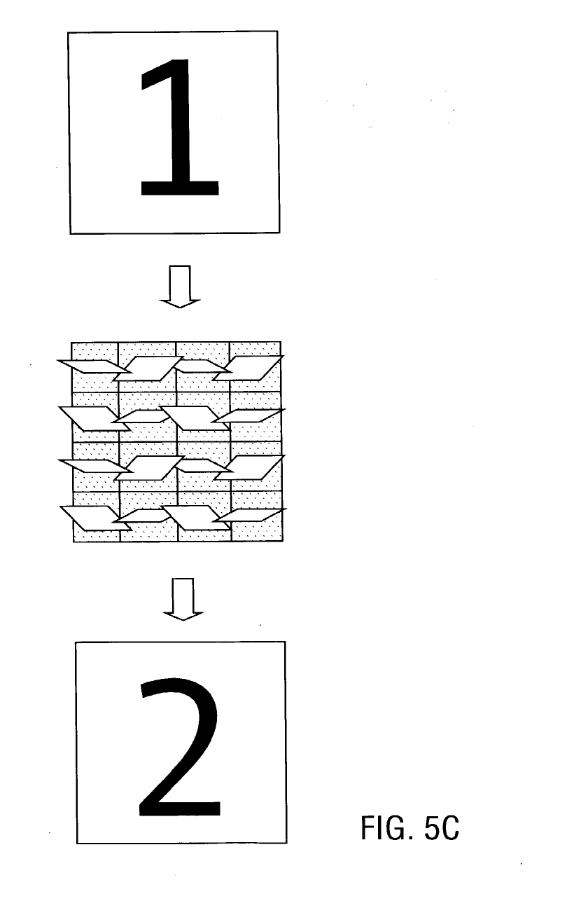

In a further embodiment, new slides are built on a plurality of tiles that shimmer or flip across the display area, as shown in FIGS. 5A to 5C. The tiles may be square tiles or rectangular tiles. The shimmering or flipping of the tiles may occur column by column as shown in FIG. 5A, or alternatively, it may occur row by row as shown in FIG. 5B. The direction of the shimmering or flipping may be controlled through a direction pop-up menu of the corresponding slide inspector, such as the direction pop-up menu 205. For example, the shimmering shown in FIG. 5A has a direction of left-to-right, while the one shown in FIG. 5B has a direction of top-to-bottom. In a further embodiment, the shimmering or flipping of the tiles may happen at substantially the same time, as shown in FIG. 5C.

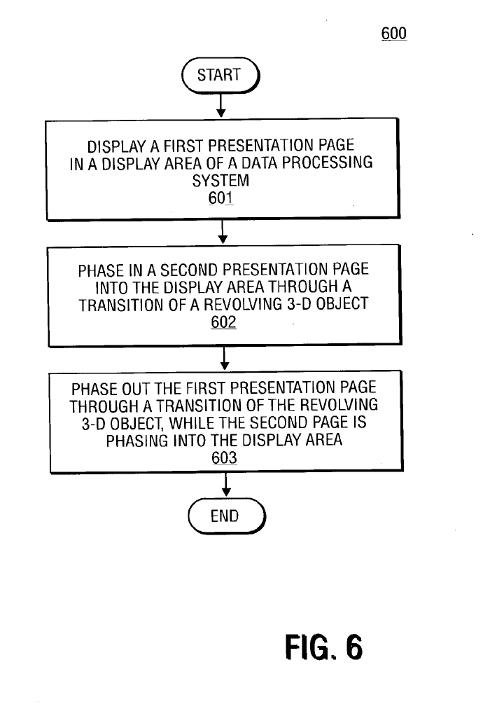

FIG. 6 is a flow diagram illustrating an exemplary process for presenting a presentation in accordance with one embodiment of the invention. Referring to FIG. 6, in one embodiment, the exemplary process 600 includes displaying a first presentation page in a display area of a data processing system, and phasing in a second presentation page into the display area while phasing out the first presentation page from the display area, wherein the phasing in and the phasing out are performed through a transition of a three-dimensional (3-D) object.

Referring to FIG. 6, at block 601, a first presentation page, such as a first slide presentation, is displayed in a display area of a data processing system. At block 602, a second presentation page (e.g., a second slide presentation) is phased into the display area through a transition of a revolving 3-D object. In one embodiment, the revolving 3-D object is a 3-D cube. In an alternative embodiment, the 3-D object is a flipping panel. In a further embodiment, the 3-D object includes multiple tiles shimmering across the display area. At block 603, the first presentation page is phased out of the display area while the second presentation page is phasing into the display area. In one embodiment, the revolving 3-D object is transitioning in an area larger than the original display area when the first presentation page is displayed. The direction and the speed of the transition of the revolving 3-D object may be controlled through a direction specifier and a speed specifier of a corresponding slide inspector, such as direction pop-up menu 205 and speed slider 209 of slide inspector 202 illustrated in FIG. 2A.

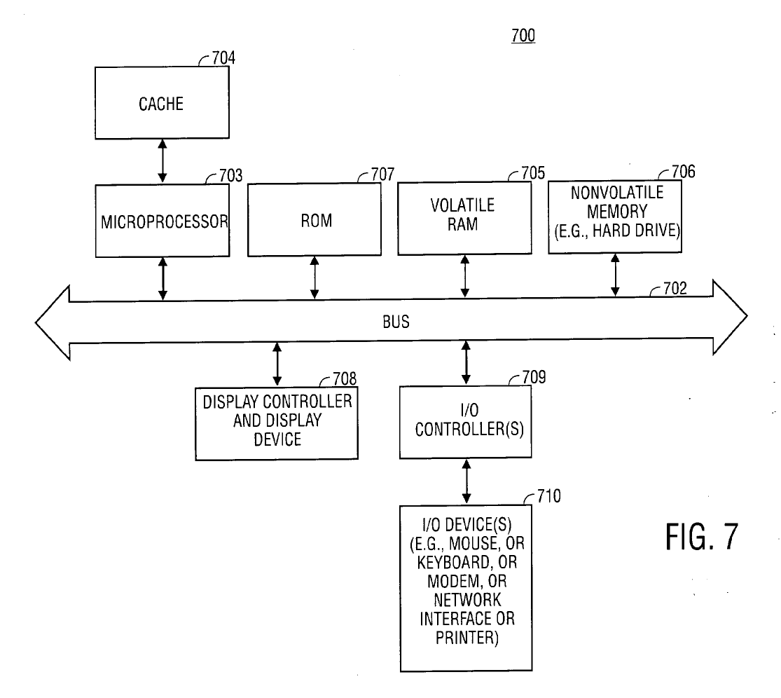

FIG. 7 is a block diagram of a digital processing system which may be used with one embodiment of the invention. For example, the system 700 shown in FIG. 7 may be used as a computer system to execute a presentation program having the above user interfaces.

Note that while FIG. 7 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 7 may, for example, be an Apple Macintosh computer.

As shown in FIG. 7, the computer system 700, which is a form of a data processing system, includes a bus 702 which is coupled to a microprocessor 703 and a ROM 707, a volatile RAM 705, and a non-volatile memory 706. The microprocessor 703, which may be a PowerPC G3 or PowerPC G4 microprocessor from Motorola, Inc. or IBM, is coupled to cache memory 704 as shown in the example of FIG. 7. The bus 702 interconnects these various components together and also interconnects these components 703, 707, 705, and 706 to a display controller and display device 708, as well as to input/output (I/O) devices 710, which may be mice, keyboards, modems, network interfaces, printers, and other devices which are well-known in the art. Typically, the input/output devices 710 are coupled to the system through input/output controllers 709. The volatile RAM 705 is typically implemented as dynamic RAM (DRAM) which requires power continuously in order to refresh or maintain the data in the memory. The non-volatile memory 706 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 7 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 702 may include one or more buses connected to each other through various bridges, controllers, and/or adapters, as is well-known in the art. In one embodiment, the I/O controller 709 includes a USB (Universal Serial Bus) adapter for controlling USB peripherals.

In one embodiment, the display device 708 may include an OpenGL compliant accelerated graphic adapter. The presentation program which employs the above user interfaces may communicate with the graphic accelerator through an OpenGL API (application programming interface) to further improve the transition between a new presentation page and an old presentation page.

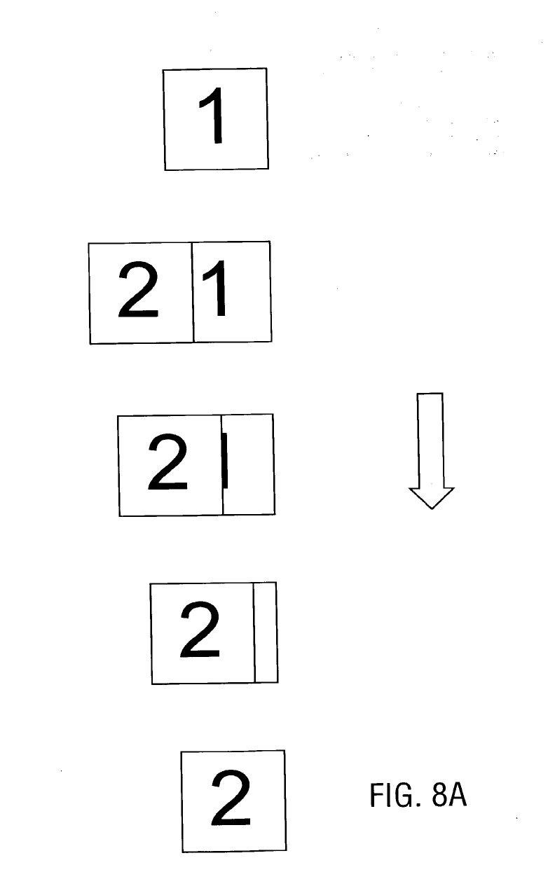

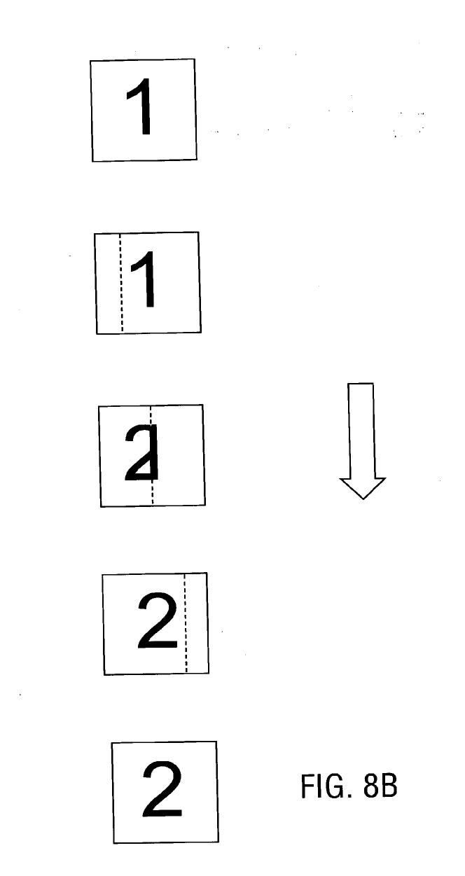

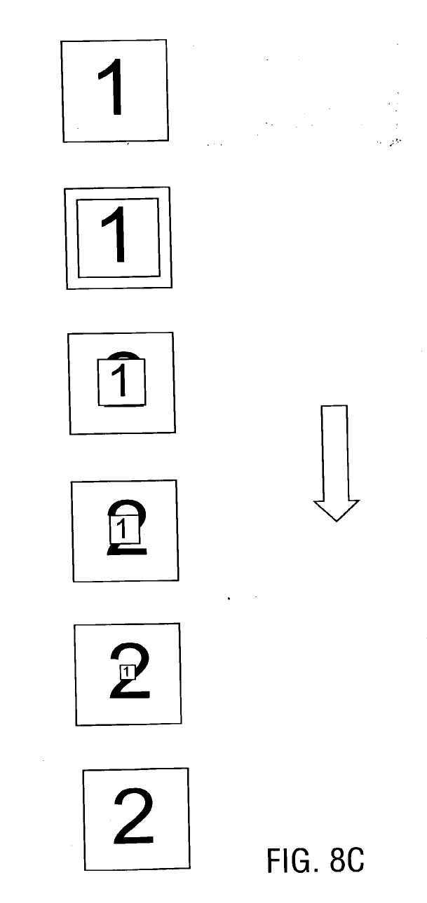

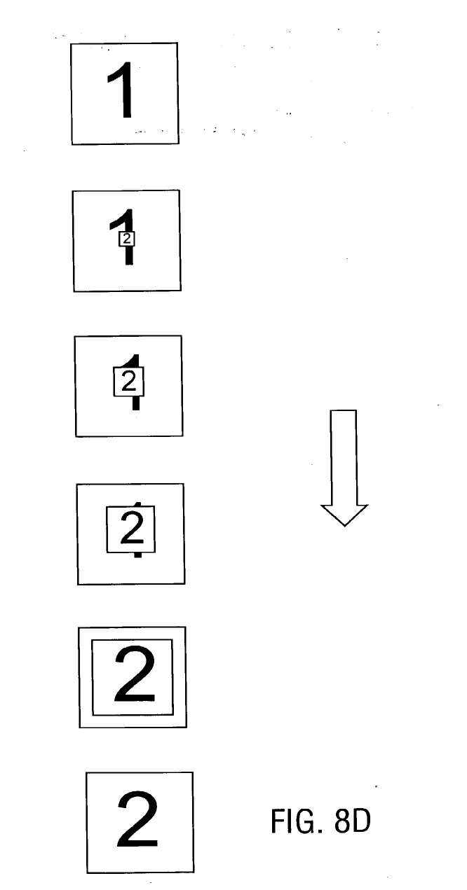

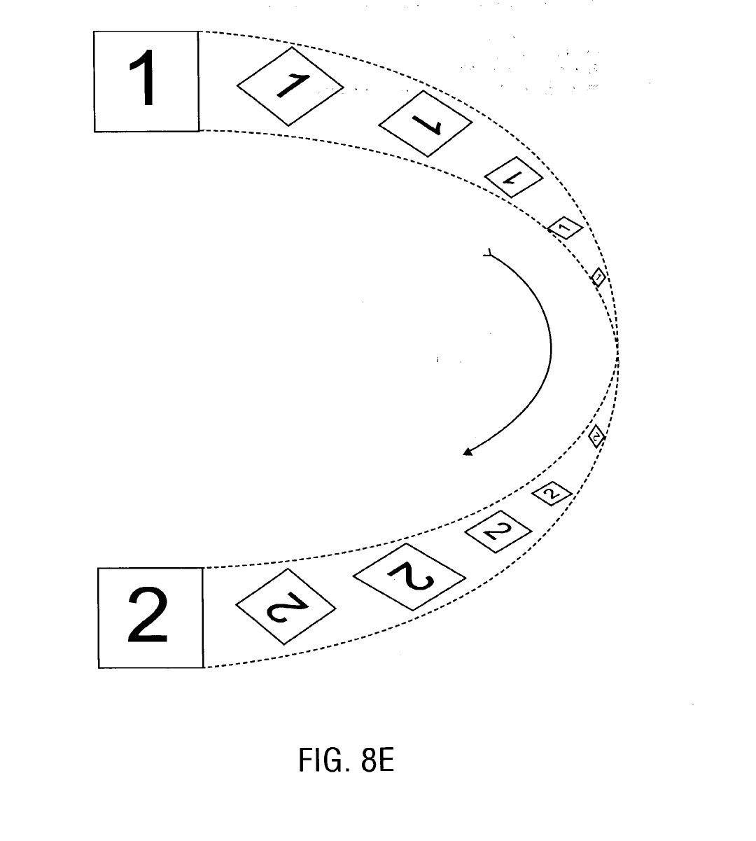

Although the above GUIs are described with a 3-D object, it would be appreciated that other objects, such as two-dimensional (2-D) objects, may be utilized. For example, according to one embodiment, a new slide may move in from one direction to cover the contents of the previous slide, as shown in FIG. 8A. In another embodiment, a new slide draws in a sweep from one direction, as the previous slide is erased from the same direction, as shown in FIG. 8B. In yet a further embodiment, a new slide grows from the center of the previous slide outward to fill the display area, as shown in FIG. 8C. The new slide may spins while it grows from the center of the previous slide. Alternatively, a previous slide may shrink away to the center of the display area and reveal the next slide, as shown in FIG. 8D. The new slide may spins while it shrinks away to the center of the display area. The above transitions may be combined, such as a transition shown in FIG. 8E. It would be appreciated that 3-D transitions and 2-D transitions may be combined to form a transition of a presentation when it is displayed. For example, the panel shown in FIG. 8E may be a 3-D object, such as a 3-D cube. Other transitions apparent to those with ordinary skills in the art may be utilized.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method to present a presentation on a data processing system, the method comprising:
displaying a first presentation page in a display area of the data processing system; and
phasing in a second presentation page into the display area while phasing out the first presentation page from the display area,
wherein the phasing in and the phasing out are performed through a transition of a three-dimensional (3-D) object.

2. The method of claim 1, wherein the phasing in and the phasing out are performed in an area larger than the display area.

3. The method of claim 1, further comprising controlling the transition of the 3-D object.

4. The method of claim 3, wherein the controlling comprises:
setting a speed of the transition of the 3-D object; and
setting a direction of the transition of the 3-D object.

5. The method of claim 4, wherein the direction includes a horizontal direction and a vertical direction.

6. The method of claim 1, wherein the first presentation page includes multiple elements, wherein the method further comprises determining how the elements are moved off the display area.

7. The method of claim 6, wherein the determining comprises setting a style, a direction, and an order for the elements to move off the display area.

8. The method of claim 1, wherein the second presentation page includes multiple elements, wherein the method further comprises determining how the elements appear on the display area.

9. The method of claim 8, wherein the determining comprises setting a style, a direction, and an order for the elements to appear on the display area.

10. The method of claim 1, wherein the 3-D object is a 3-D cube and wherein the first presentation page is phased in via a first surface of the 3-D cube and the second presentation page phased out via a second surface of the 3-D cube.

11. The method of claim 10, further comprising revolving the 3-D cube to phase out the first presentation page and to phase in the second presentation page, and wherein the number of presentation pages in a presentation file exceeds the number of sides of the 3-D cube.

12. The method of claim 1, wherein the 3-D object is a 3-D panel and wherein the first presentation page phased in via a first side of the 3-D panel and the second presentation page phased out via a second side of the 3-D panel.

13. The method of claim 12, further comprising flipping the 3-D panel to phase out the first presentation page and to phase in the second presentation page.

14. The method of claim 1, wherein the 3-D object includes a plurality of tiles flipping or shimmering across the display area to phase out the first presentation page and to phase in the second presentation page.

15. The method of claim 14, wherein the flipping or shimmering is performed column by column or row by row.

16. A method for presenting slide presentations on a data processing system, the method comprising:
displaying a first slide presentation in a display area of a screen; and
angling and turning the first slide presentation off the screen while a second slide presentation angling on the screen, as though the first and second slide presentations are sides of a revolving three-dimensional (3-D) object.

17. The method of claim 16, wherein the 3-D object is a 3-D object selected from the group consisting of:
a cube;
a panel; and
a plurality of tiles shimmering or flipping across the screen.

18. The method of claim 16, further comprising:
controlling a speed of the revolving 3-D object; and
controlling a direction of the revolving 3-D object.

19. The method of claim 16, wherein the revolving 3-D object occupies an area larger than the display area during the revolving.

20. A machine-readable medium having executable code to cause a machine to perform a method to present a presentation on a data processing system, the method comprising:
displaying a first presentation page in a display area of the data processing system; and
phasing in a second presentation page into the display area while phasing out the first presentation page from the display area,
wherein the phasing in and the phasing out are performed through a transition of a three-dimensional (3-D) object.

21. The machine-readable medium of claim 20, wherein the phasing in and the phasing out are performed in an area larger than the display area.

22. The machine-readable medium of claim 20, wherein the method further comprises controlling the transition of the 3-D object.

23. The machine-readable medium of claim 22, wherein the controlling comprises:
setting a speed of the transition of the 3-D object; and
setting a direction of the transition of the 3-D object.

24. The machine-readable medium of claim 23, wherein the direction includes a horizontal direction and a vertical direction.

25. The machine-readable medium of claim 20, wherein the first presentation page includes multiple elements, wherein the method further comprises determining how the elements are moved off the display area.

26. The machine-readable medium of claim 25, wherein the determining comprises setting a style, a direction, and an order for the elements to move off the display area.

27. The machine-readable medium of claim 20, wherein the second presentation page includes multiple elements, wherein the method further comprises determining how the elements appear on the display area.

28. The machine-readable medium of claim 27, wherein the determining comprises setting a style, a direction, and an order for the elements to appear on the display area.

29. The machine-readable medium of claim 20, wherein the 3-D object is a 3-D cube and wherein the first presentation page is phased in via a first surface of the 3-D cube and the second presentation page phased out via a second surface of the 3-D cube.

30. The machine-readable medium of claim 29, wherein the method further comprises revolving the 3-D cube to phase out the first presentation page and to phase in the second presentation page, and wherein the number of presentation pages in a presentation file exceeds the number of sides of the 3-D cube.

31. The machine-readable medium of claim 20, wherein the 3-D object is a 3-D panel and wherein the first presentation page phased in via a first side of the 3-D panel and the second presentation page phased out via a second side of the 3-D panel.

32. The machine-readable medium of claim 31, wherein the method further comprises flipping the 3-D panel to phase out the first presentation page and to phase in the second presentation page.

33. The machine-readable medium of claim 20, wherein the 3-D object includes a plurality of tiles flipping or shimmering across the display area to phase out the first presentation page and to phase in the second presentation page.

34. The machine-readable medium of claim 33, wherein the flipping or shimmering is performed column by column or row by row.

35. A machine-readable medium having executable code to cause a machine to perform a method to present a presentation on a data processing system, the method comprising:
displaying a first slide presentation in a display area of a screen; and
angling and turning the first slide presentation off the screen while a second slide presentation angling on the screen, as though the first and second slide presentations are sides of a revolving three-dimensional (3-D) object.

36. The machine-readable medium of claim 35, wherein the 3-D object is a 3-D object selected from the group consisting of:
a cube;
a panel; and
a plurality of tiles shimmering or flipping across the screen.

37. The machine-readable medium of claim 35, wherein the method further comprises:
controlling a speed of the revolving 3-D object; and
controlling a direction of the revolving 3-D object.

38. The machine-readable medium of claim 35, wherein the revolving 3-D object occupies an area larger than the display area during the revolving.

39. An apparatus for presenting a presentation on a data processing system, the apparatus comprising:
means for displaying a first presentation page in a display area of the data processing system; and
means for phasing in a second presentation page into the display area while phasing out the first presentation page from the display area,
wherein the phasing in and the phasing out are performed through a transition of a three-dimensional (3-D) object.

40. The apparatus of claim 39, wherein the phasing in and the phasing out are performed in an area larger than the display area.

41. The apparatus of claim 39, further comprising means for controlling the transition of the 3-D object.

42. The apparatus of claim 41, wherein means for controlling comprises:
means for setting a speed of the transition of the 3-D object; and
means for setting a direction of the transition of the 3-D object.

43. The apparatus of claim 42, wherein the direction includes a horizontal direction and a vertical direction.

44. The apparatus of claim 39, wherein the first presentation page includes multiple elements, wherein the apparatus further comprises means for determining how the elements are moved off the display area.

45. The apparatus of claim 44, wherein the determining comprises setting a style, a direction, and an order for the elements to move off the display area.

46. The apparatus of claim 39, wherein the second presentation page includes multiple elements, wherein the apparatus further comprises means for determining how the elements appear on the display area.

47. The apparatus of claim 46, wherein the determining comprises setting a style, a direction, and an order for the elements to appear on the display area.

48. The apparatus of claim 39, wherein the 3-D object is a 3-D cube and wherein the first presentation page is phased in via a first surface of the 3-D cube and the second presentation page phased out via a second surface of the 3-D cube.

49. The apparatus of claim 48, further comprising means for revolving the 3-D cube to phase out the first presentation page and to phase in the second presentation page.

50. The apparatus of claim 39, wherein the 3-D object is a 3-D panel and wherein the first presentation page phased in via a first side of the 3-D panel and the second presentation page phased out via a second side of the 3-D panel.

51. The apparatus of claim 50, further comprising means for flipping the 3-D panel to phase out the first presentation page and to phase in the second presentation page.

52. The apparatus of claim 39, wherein the 3-D object includes a plurality of tiles flipping or shimmering across the display area to phase out the first presentation page and to phase in the second presentation page.

53. The apparatus of claim 52, wherein the flipping or shimmering is performed column by column or row by row.

54. A method for presenting slide presentations on a data processing system, the method comprising:
displaying a first slide presentation in a display area of a screen; and
angling and turning the first slide presentation off the screen while a second slide presentation angling on the screen, as though the first and second slide presentations are sides of a revolving three-dimensional (3-D) object.

55. The method of claim 16, wherein the 3-D object is a 3-D object selected from the group consisting of:
a cube;
a panel; and
a plurality of tiles shimmering or flipping across the screen.

56. The method of claim 16, further comprising:
controlling a speed of the revolving 3-D object; and
controlling a direction of the revolving 3-D object.

57. The method of claim 16, wherein the revolving 3-D object occupies an area larger than the display area during the revolving.

58. An apparatus for presenting a presentation on a data processing system, the apparatus comprising:
means for displaying a first slide presentation in a display area of a screen; and
means for angling and turning the first slide presentation off the screen while a second slide presentation angling on the screen, as though the first and second slide presentations are sides of a revolving three-dimensional (3-D) object.

59. The apparatus of claim 58, wherein the 3-D object is a 3-D object selected from the group consisting of:
a cube;
a panel; and
a plurality of tiles shimmering or flipping across the screen.

60. The apparatus of claim 58, further comprising:
means for controlling a speed of the revolving 3-D object; and
means for controlling a direction of the revolving 3-D object.

61. The apparatus of claim 58, wherein the revolving 3-D object occupies an area larger than the display area during the revolving.

62. A data processing system, comprising:
a processor; and
a memory coupled to the processor to store instructions that causes the processor to perform the operations of presenting a presentation, the operations including:
displaying a first presentation page in a display area of the data processing system; and
phasing in a second presentation page into the display area while phasing out the first presentation page from the display area,
wherein the phasing in and the phasing out are performed through a transition of a three-dimensional (3-D) object.

63. A data processing system, comprising:
a processor; and
a memory coupled to the processor to store instructions that causes the processor to perform the operations of presenting a presentation, the operations including:
displaying a first slide presentation in a display area of a screen; and
angling and turning the first slide presentation off the screen while a second slide presentation angling on the screen, as though the first and second slide presentations are sides of a revolving three-dimensional (3-D) object.
